(19) United States
(12) Patent Application Publication
(10) Pub. No.: US 2019/0257962 A1
(43) Pub. Date: Aug. 22, 2019

(54) Method And Monolithic Device For Characterising The Quality Of An X-Ray Beam

(71) Applicants: Universite Claude Bernard Lyon 1, Villeurbanne (FR); Centre National de la Recherche Scientifique (CNRS), Paris (FR); Institut National des Sciences Appliquees de Lyon, Paris (FR); Ecole Centrale De Lyon, Ecully (FR)

(72) Inventors: Guo-Neng Lu, Saint Fons (FR); Patrick Pittet, Fontaines Saint Martin (FR); Ruoxi Wang, Beijing (CN)

(73) Assignees: Universite Claude Bernard Lyon 1, Villeurbanne (FR); Centre National de la Recherche Scientifique (CNRS), Paris (FR); Institut National des Sciences Appliquees de Lyon, Villeurbanne (FR); Ecole Centrale De Lyon, Ecully (FR)

(21) Appl. No.: 16/310,033

(22) PCT Filed: Jun. 16, 2017
(86) PCT No.: PCT/FR2017/051577

§ 371 Date: Dec. 14, 2018

(30) Foreign Application Priority Data
Jun. 16, 2016 (FR) 1655609

(51) Int. Cl. G01T 1/29; G01T 1/24

(52) U.S. Cl. CPC G01T 1/29; G01T 1/242

(57) ABSTRACT

The invention relates to a method for characterising the quality of an X-ray beam having a known profile for depositing a dose in a body, having an zone (Zₐ₁, Zₐ₂) of increasing dose rate inside said body extending between the input surface of the beam and a characteristic depth (Pₘₐₓ) where the deposited dose is at a maximum, the method comprising the following steps: —providing a monolithic detector including in p-n junctions (m>3) stacked depth-wise in the detector with at least three junctions distributed in the zone of increasing dose rate; —projecting said X-ray beam onto the monolithic detector; —recovering the m signals (r) delivered by the p-n junctions of the detector; —and processing the m signals (r) in order to characterise the quality of the X-ray beam.

The present invention relates to the technical field of characterization of the quality of X-ray beams and it focuses more particularly on characterization of the quality of X-ray beams in the field of medical imaging.

In the field of radiology especially, it seems necessary to characterize the quality of the X-ray beams used, for questions of quality assurance and radioprotection of patients and personnel. The principal dosimetric property of X-ray beams in the range 40-150 kVp is that the dose reaches its maximum close to the surface of the patient, that is, in the first millimeters and decreases with the depth, the speed of decrease depending on energetic properties of the incident beam (Robin Hill et al. Phys. Med. Bio. 59 (2014) R183R231). In general, the characterization of the quality of X-ray beams is based on the speed of decrease of the dose rate as a function of the depth after the dose rate maximum. The quality of beam is directly linked to the spectral characteristics of the X-ray beam and especially to the average power of this spectrum.

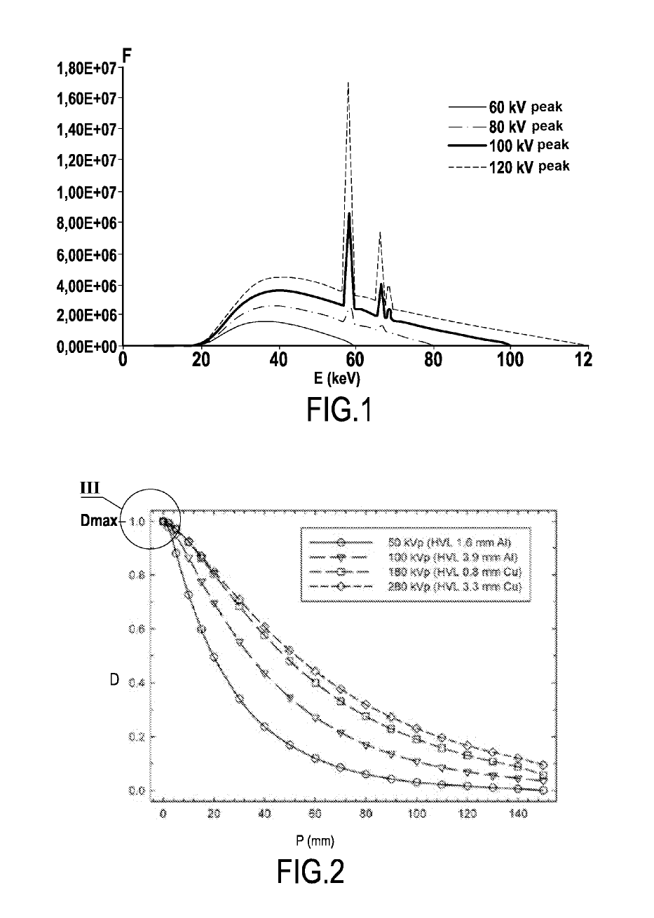

FIG. 1 shows the spectral evolution of X-ray beams obtained for different voltages of the production tube of the X-ray beams, the other parameters being fixed (angle, filtration, material and thickness of the window, form of the collimator, . . . ). Each spectrum has a different average power and therefore a specific beam quality.

In this field, it is known to characterize the energetic properties of an X-ray beam by using attenuating metallic material and by determination of the semiattenuation thickness that is, the thickness necessary to reduce the dose rate by half (Ma et al. Medical Physics Vol, 28, N^{o}. 6 2001). It is common to use a stack of metal sheets to determine the semi attenuation thickness. This manual method has a relatively long execution and does not offer access to various other parameters useful for characterizing the quality of X-ray beams. To facilitate this execution, patent application US 2013-016808-A1 proposes a system for continuously varying the thickness of the attenuating material.

Another approach for characterizing an X-ray beam, described in patent U.S. Pat. No. 5,761,270, on which is based an instrument by the company RAYSAFE, consists of using different attenuating metallic filters on a matrix of silicon diodes. This instrument has limited spatial resolution since it cannot be less than the size of the matrix. To increase the spatial resolution, patent U.S. Pat. No. 9,405,021 describes a detector comprising several diodes stacked at distances from each other with a radiating filter between each level of diodes. Also, even if the instruments described in these two patents are compact they have the disadvantage of not being radio-transparent.

Yet another method is based on attenuation of the dose with the depth in water and proposes using the ratio of dosimetric measurements at two depths in water, typically at 2 cm and 5 cm, to specify the quality of the beam (K. R. Rosser, “An alternative beam quality index for medium-energy x-ray dosimetry,” Phys. Med. Biol. 43, 587-598, 1998). This method does not develop a compact system and rapid characterization of the quality of the beam.

The present invention aims to rectify the disadvantages of the prior art by proposing a novel technique for acquiring in real time various information on the power characteristics of an X-ray beam for characterizing its quality, and having high spatial resolution.

Another aim of the invention is to propose a technique designed to characterize the quality of an X-ray beam and allowing it to be radio-transparent.

To achieve such aims, the invention aims to propose a method for characterizing the quality of an X-ray beam comprising a known profile of dose deposit in a body having a zone of increasing dose rate inside said body extending between the input surface of the beam and a characteristic depth where the deposited dose rate is maximal, the method comprising the following steps:
projecting said X-ray beam onto a monolithic detector integrating m junctions p-n stacked (m>=3) depthwise of said detector with at least three junctions distributed in the zone of increasing dose rate;
retrieving the m signals delivered by the junctions p-n of the detector; and
processing the m signals for characterizing the quality of the X-ray beam.

According to an advantageous variant embodiment, the method consists of processing the m signals by calculating m−1 relative differentiation values of the following first order

$${d}_{i} = \frac{( {r}_{i + 1} - {r}_{i} )}{\frac{( {r}_{i + 1} + {r}_{i} )}{2}} {\vert}_{i = 1 à m - 1}$$

According to another advantageous variant embodiment, from the m−1 relative differentiation values of first order, the method consists of calculating the m−2 relative differentiation values of the following second order:

$${d}_{i}^{′} = \frac{( {d}_{i + 1} - {d}_{i} )}{\frac{( {d}_{i + 1} + {d}_{i} )}{2}} {\vert}_{i = 1 à m - 2}$$

Advantageously, the method consists, from the m values of signals r, m−1 relative differentiation values of first order dᵢ and of the m−2 relative differentiation values of the second order d_{′i}, determining the appearance of the profile of dose deposit rate on the zone of increasing dose rate as well as the characteristic depth.

According to an advantageous characteristic, the method consists of determining the curvature of the profile of the dose rate from the m−2 relative differentiation values of the second order. This curvature in zone of increasing dose rate assumes negative values and presents a monotone function of the power characteristic of the beam, coming up to the quality of the incident X-ray beam.

Advantageously, the method consists of determining the growth rate of the profile of the dose rate on the region before electronic balance (region called “build-up”), from the m−1 relative differentiation values of first order, this growth rate coming up to the quality of the incident X-ray beam.

According to another advantageous variant embodiment, from the m−1 relative differentiation values of first order and the m−2 relative differentiation values of the second order, the method consists of constituting a vector of 2m−3 elements defined by:

$$D = [ \begin{matrix}{d}_{1} \\ ⋮ \\ {d}_{m - 1} \\ {d}_{1}^{′} \\ ⋮ \\ {d}_{m - 2}^{′}\end{matrix} ]$$

According to another advantageous variant embodiment, from the m−1 relative differentiation values of first order and the m−2 relative differentiation values of the second order, the method consists of constituting a vector of 2m−3 elements defined by:

$$D = [ \begin{matrix}{α}_{1} {d}_{1} \\ ⋮ \\ {α}_{m - 1} {d}_{m - 1} \\ {α}_{1}^{′} {d}_{1}^{′} \\ ⋮ \\ {α}_{m - 2}^{′} {d}_{m - 2}^{′}\end{matrix} ]$$

where α₁ . . . αₘ₋₁, and α′₁ . . . α′_{m1_2} are weighting coefficients between 0 and 1.

For example, for equipment generating X-rays whereof the power settings produce n spectra with different beam qualities, the method consists of determining the vectorial correlation between the measured vector and n predetermined reference vectors corresponding to these n spectra, the correlation maximum indicating the spectrum of the X-ray beam and therefore the quality of this beam.

For example, for equipment generating X-rays whereof the settings including filtration produce k use configurations with different beam qualities, the method consists of determining the vectorial correlation between the measured vector and k reference vectors predetermined for these configurations, the correlation maximum indicating the configuration used and therefore the quality of the X-ray beam.

Advantageously, the method consists of exploiting both the m signals of the junctions p-n which are proportional to the dose rate of the incident beam and also the quality of beam for determining the dose rate at a given depth that is, at points of interest.

According to an advantageous embodiment characteristic, the method consists of distributing the m junctions p-n so as to position at least three junctions p-n in the zone of increasing dose rate for the X-ray beam with the lowest level of power, and at least two junctions p-n near the characteristic depth for the X-ray beam with the highest level of power.

The invention also aims to propose a device for characterizing the quality of an X-ray beam comprising a known profile of dose deposit in a body, having a zone of increasing dose rate inside said body extending between the input surface of the beam and a characteristic depth where the deposited dose rate is maximal. The device according to the invention comprises a monolithic detector having m junctions p-n stacked depthwise of said detector with at least three of said junctions distributed in a zone corresponding to the zone of increasing dose rate for the lowest beam quality index of the measuring zone, the detector being connected to a measuring and processing circuit retrieving the m signals delivered by the m junctions p-n of the detector and processing the m signals for characterizing the quality of the X-ray beam.

According to an embodiment, the monolithic detector having m junctions p-n stacked depthwise is a detector having multiple buried junctions p-n or a detector obtained by manufacturing processes or 3D microelectronic integration. Advantageously, at least three of the junctions p-n are distributed in a depth zone at most equal to 20 pm from the exposed face of the monolithic detector.

According to a characteristic of the invention, the measuring and processing circuit is adapted for:
retrieving the m signals rᵢ originating from the junctions p-n from the m signals delivered by the detector;
calculating the following relative m−1 differentiation magnitudes:

$${d}_{i} = \frac{( {r}_{i + 1} - {r}_{i} )}{\frac{( {r}_{i + 1} + {r}_{i} )}{2}} {\vert}_{i = 1 à m - 1}$$

calculating, from the relative m−1 differentiation magnitudes, the relative m−2 differentiation magnitudes of the following second order:

$${d}_{i}^{′} = \frac{( {d}_{i + 1} - {d}_{i} )}{\frac{( {d}_{i + 1} + {d}_{i} )}{2}} {\vert}_{i = 1 à m - 2}$$

According to another characteristic of the invention, the measuring and processing circuit is adapted for calculating the maximum of the vectorial correlation between n reference vectors and the following vector having 2m−3 elements:

$$D = [ \begin{matrix}{α}_{1} {d}_{1} \\ ⋮ \\ {α}_{m - 1} {d}_{m - 1} \\ {α}_{1}^{′} {d}_{1}^{′} \\ ⋮ \\ {α}_{m - 2}^{′} {d}_{m - 2}^{′}\end{matrix} ]$$

where α₁ . . . αₘ₋₁, and α′₁ . . . α′_{m1_2} are weighting coefficients between 0 and 1.

Various other characteristics will emerge from the description given hereinbelow in reference to the appended drawings which show by way of non-limiting examples embodiments of the subject matter of the invention.

FIG. 1 shows the spectral evolution of X-ray beams (flow F in KeV⁻¹·cm⁻²·mA⁻¹·s⁻¹) as a function of the power E (keV), and for different voltages of the production tube of the X-ray beams.

FIG. 2 illustrates the relative dose rate profile D of an X-ray beam as a function of the depth P (mm) inside a body, for different voltages of the production tube of the X-ray beams.

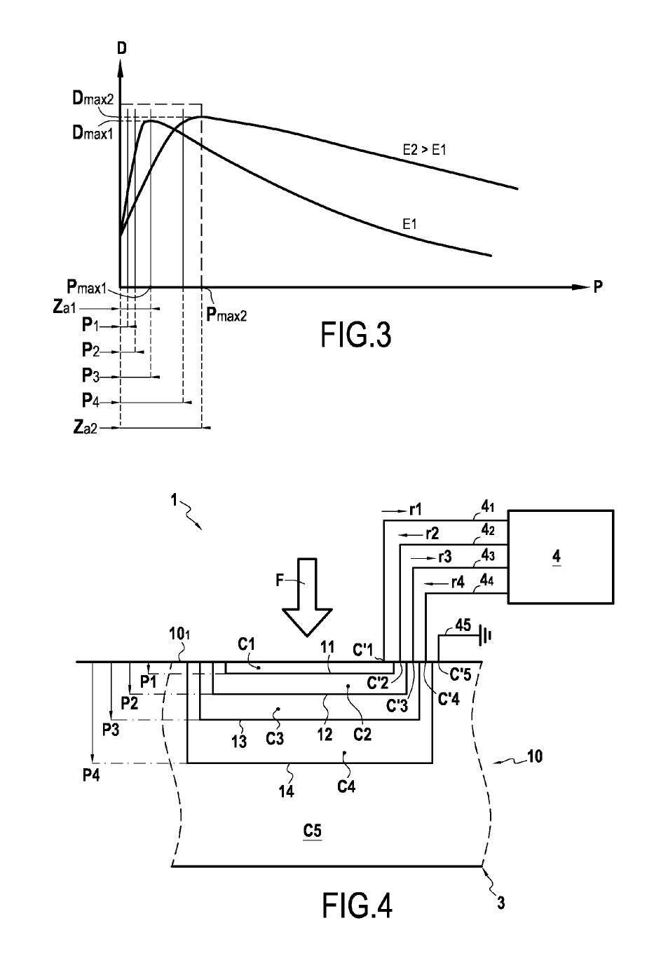

FIG. 3 illustrates the evolution of the relative dose rate D in the zone of increasing dose rate extending between the input surface of the beam and a characteristic depth P where the deposited dose rate is maximal.

FIG. 4 is an embodiment of a device for characterizing the quality of an X-ray beam.

FIG. 5 is another embodiment of a device for characterizing the quality of an X-ray beam allowing irradiation by the rear face.

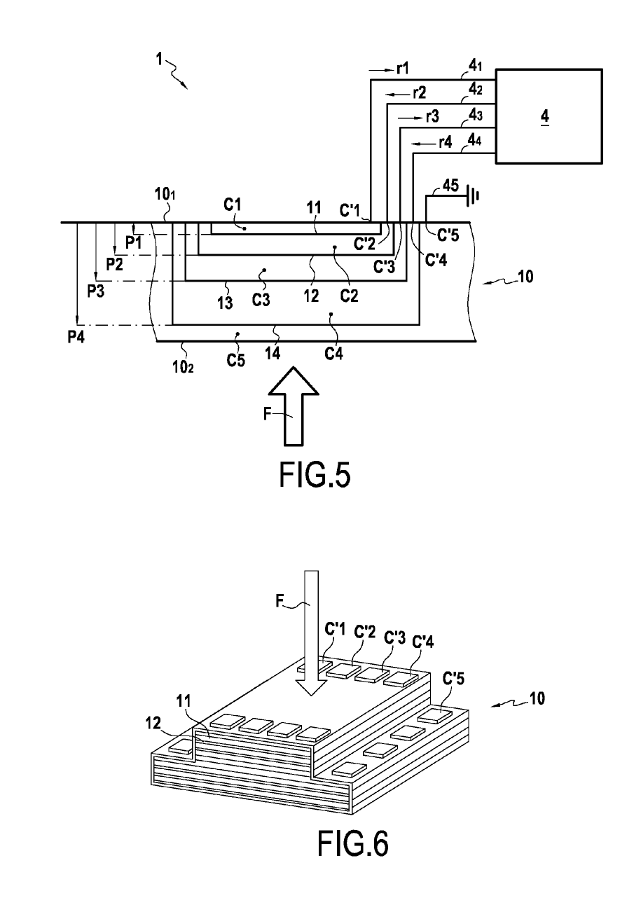

FIG. 6 is an embodiment of a detector obtained by manufacturing processes or 3D microelectronic integration.

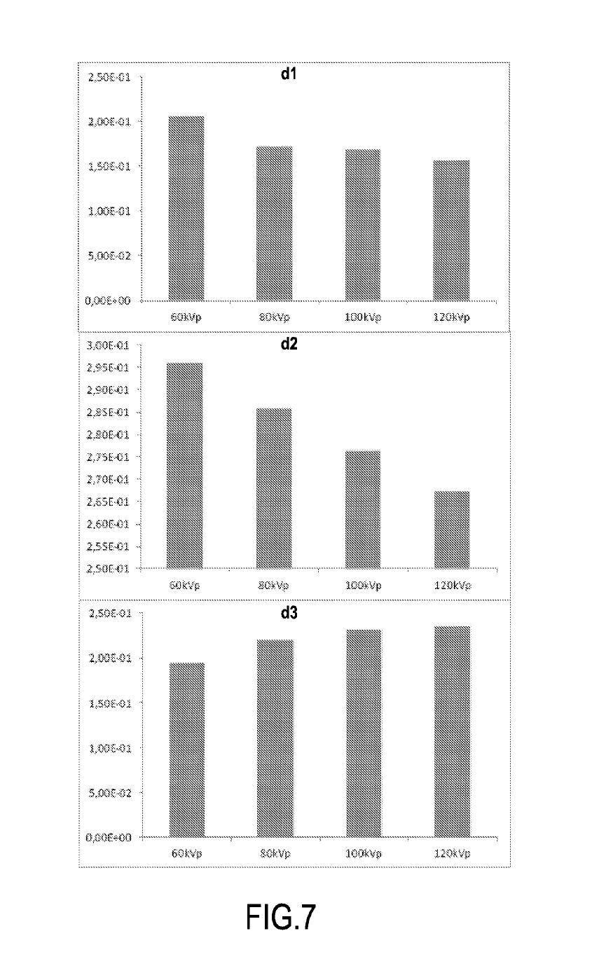

FIG. 7 illustrates the relative differentiation values of first order of the signals delivered by the detector, for different powers of the X-ray beam.

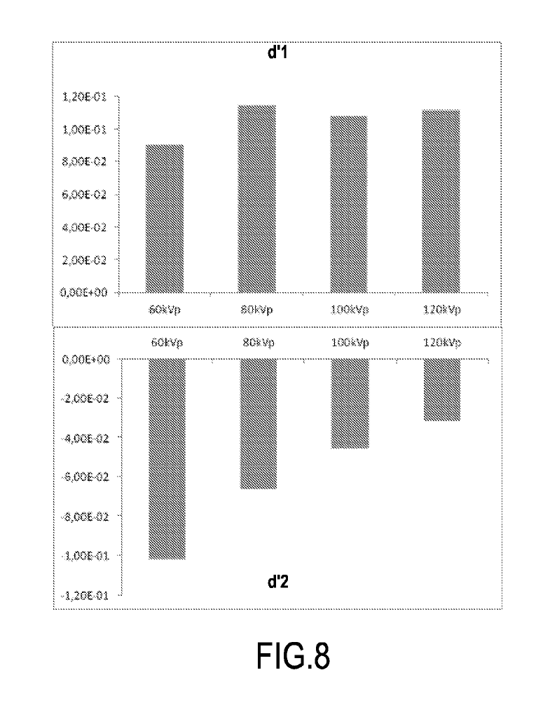

FIG. 8 illustrates the relative differentiation values of second order of the four signals delivered by the detector, for different powers of the X-ray beam.

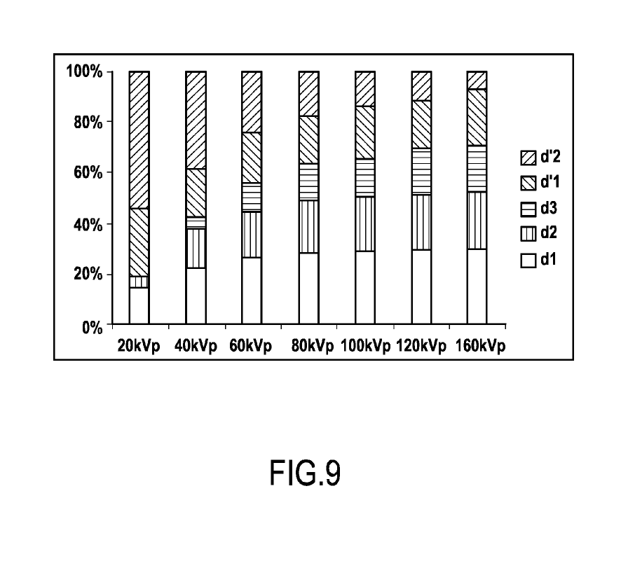

FIG. 9 illustrates the values of a relative differentiation vector of the signals delivered by the detector, for different powers of the X-ray beam.

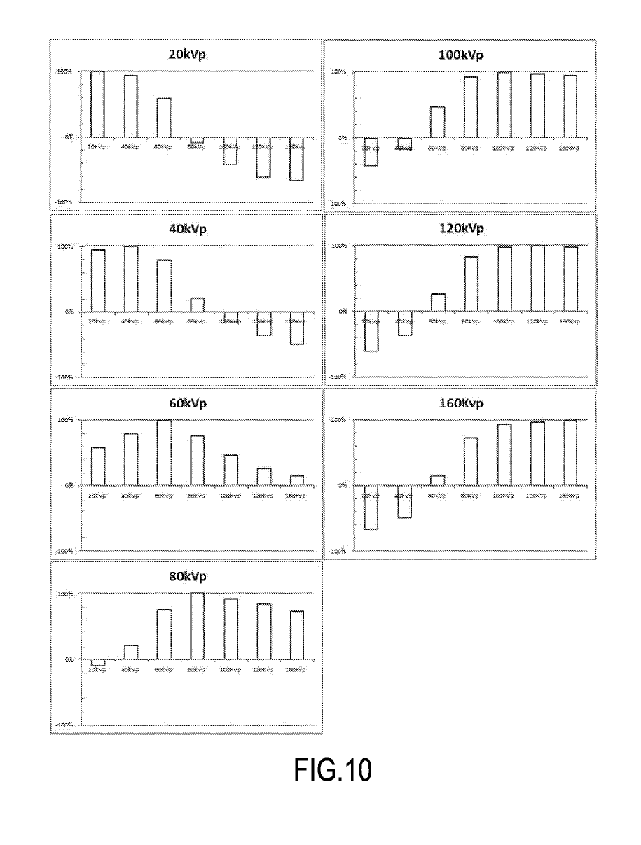

FIG. 10 illustrates the values of correlation for different powers of the X-ray beam, between the relative differentiation vector for the X-ray beam and tabulated reference vectors.

The aim of the invention relates to a silicon-based device 1 adapted for characterizing the quality of an X-ray beam F comprising a known profile of dose deposit in a body, currently designated by performance depthwise (“depth-dose curve” or “percentage depth dose distribution”). FIG. 2 illustrates the relative dose rate profile D of an X-ray beam as a function of the depth P inside a body, for different power spectra which correspond to different supply voltages of the production tube of the X-ray beam (Robin Hill et al. Phys. Med. Bio. 59 (2014) R183-R231). It is therefore known that the dose rate of an X-ray beam decreases as a function of the depth after the maximum dose rate Dₘₐₓ. In the range 40-150 kVp, Dₘₐₓ is in the first millimeters of the input surface of the beam in a body. It should be noted that in the case of silicon, this maximum is between a few micrometers and tens of micrometers. This macroscopic representation which is widely used in the prior art results in considering that the maximum dose rate Dₘₐₓ is at the entry of the body.

However, this macroscopic consideration does not consider the fact that the dose rate of an X-ray beam presents a rapid increasing dose rate zone inside said body. As is evident more precisely from FIG. 3, (www.naweb.iaea.org/DMRP/documents/Chapter6.pdf) the relative dose rate D of an X-ray beam presents a zone of increasing dose rate Zₐ extending between the input surface of the beam (Z=0) and a characteristic depth Pₘₐₓ where the deposited dose rate Dₘₐₓ is maximal. This superficial zone of increasing dose rate Za extending as far as the characteristic depth Pₘₐₓ, is designated by “build-up” and depends on the energetic properties of the X-ray beam.

As is evident from FIG. 3, the absorbed dose is the highest not at the surface of the body, but at a depth P all the more so since the average power of the spectrum of the X-ray beam is high. Therefore, for an X-ray beam F2, having average power <E2> greater than average power <E1> of X-ray beam F, the characteristic depth Pₘₐₓ₂ where the deposited dose rate Dₘₐₓ is maximal, is greater than the characteristic depth Pₘₐₓ₁ for the X-ray beam of power E1. In other terms, the zone of increasing dose rate Zₐ₁ for the X-ray beam of average power <E1> is smaller than the zone of increasing dose rate Zₐ₂ for the X-ray beam of average power <E2>.

As emerges more precisely from FIG. 4, the device 1 according to the invention for characterizing the quality of an X-ray beam F, comprises a detector 3 monolithically integrating m junctions p-n stacked depthwise relative to its surface and whereof at least three of these junctions p-n are distributed in the increasing zone of dose rate Zₐ of an X-ray beam.

The m junctions p-n of the detector 3 deliver m electrical signals. The detector 3 is linked to a measuring and processing circuit 4 retrieving the m signals delivered by the detector 3. As will be explained below in the description, this circuit 4 processes the m signals delivered by the detector 3 to characterize the quality of the X-ray beam. This measuring and processing circuit 4 can be realized in any appropriate manner by electronic circuits or computer.

In keeping with the invention, the detector 3 having m junctions p-n stacked depthwise is a detector having multiple buried junctions p-n or a detector obtained by manufacturing processes or 3D microelectronic integration. Irrespective of the manufacturing method, the detector 3 is a monolithic component integrating the m junctions p-n stacked depthwise in this monolithic component.

According to a preferred embodiment, the monolithic detector 3 is a BMJ (Buried Multiple pn Junction) detector, and described by patent U.S. Pat. No. 5,883,421. This type of detector has been used to date as photodetector in the visible and close infrared spectral fields and in this context, for example with four buried junctions p-n, allows quantitative analysis of several fluorescent markers emitting in this spectral range (Thierry Courcier et al., Sensors and Actuators B 190 (2014) 288-2941). By contrast, this type of detector has never been proposed in the literature for detecting photons X.

In this preferred embodiment, the detector 3 according to the invention comprises a silicon-based semi-conductor structure 10 comprising successively in the example illustrated four junctions p-n respectively 11 to 14. These junctions 11 to 14 are buried respectively at increasing depths P1 to P4 taken from a surface of the silicon 101 so-called front face of the semi-conductor structure 10. These junctions 11 to 14 are obtained by creating five zones C1 to C5 with different dopings alternatively p and n, distributed over the depth of the silicon substrate. The interface between two adjacent zones determines the depth of the corresponding junction. Therefore, the first junction 11 is located at the interface between the first zone C1 and the second zone C2, the second junction 12 the second zone C2 and the third zone C3, the third junction 13 between the third zone C3 and the fourth zone C4 and the fourth junction 14 between the fourth zone C4 and the fifth zone C5. In the example illustrated, the first to fifth zones C1 to C5 are respectively of types P, N, P, N, P and are produced by microelectronic manufacturing processes such as implantation ionic and diffusion. It is possible to reverse the dopings of the structure that is, of types N, P, N, P, N, for manufacture of the monolithic detector 3.

In the example illustrated in FIG. 4, the surface 101 of the structure 10 in relation to the first zone C1 comprises a part intended to receive the incident X-ray beam F. According to the embodiment illustrated in FIG. 5, the monolithic detector 3 comprises a tapered substrate that is, a fifth and final zone C5 of minimal thickness such that attenuation of the beam F by the detector remains limited and accordingly the detector may be considered as radio-transparent. In this embodiment it can be advantageous to expose to the incident X-ray beam F the rear face 102 of the semi-conductor structure 10, opposite the front surface 104 to exploit the fact that the deep zones are typically less doped and therefore produce better detection sensitivity for the corresponding junction (specifically the fourth junction 14 in the example illustrated) with a load zone of wider space which is well adapted to the low dose rates in the immediate proximity of the irradiated surface. This execution allows better signal-to-noise ratio over all the junctions.

Also, each of the zones C1 to C5 is accessible on the front surface 101, respectively via a connection zone C′1 to C′5. These connection zones C′1 to C′5 enable connection with the circuit 4. This circuit 4 comprises five branches 4₁ to 4₅ connected respectively to the connection zones C′1 to C′5. Whereas the fifth branch 4s is connected to earth, the four other branches are used for reading the output signals of the junctions 11 to 14 and also polarise these junctions with adequate electrical potentials.

When an X-ray beam irradiates the front surface 101 of the structure 10, internal currents passing through the four junctions 11 to 14 and retrieved by the branches of the circuit 4 appear via photoelectrical effect. Therefore, the first branch 41 retrieves the current r₁ circulating in the first junction 11 while the current r₂ passes through the second branch 42 by circulating in the first and second junctions 11, 12. Similarly, the third branch 43 retrieves the current r₃ circulating in the second and third junctions 12, 13 while the fourth branch 44 retrieves the current r₄ circulating in the third and fourth junctions 13, 14. From an electronic viewpoint, the illustrated semi-conductor structure 10 is equivalent to four superposed photodiodes. Therefore, it must be understood that the circuit 4 retrieves m electrical signals r₁ (i=1, 2 . . . m) for a detector having m junctions p-n.

The monolithic detector 3 described hereinabove is made by microelectronic manufacturing processes (epitaxy, ionic implantation, etc.). It should be noted that in the event where the detector comprises a high number of junctions p-n stacked superposed as illustrated in FIG. 5, such a detector can be made by three-dimensional microelectronic integration techniques.

To the extent where the monolithic detector 3 is intended to receive X-ray beams having different average powers, at least three of these junctions p-n stacked depthwise are distributed in the zone of increasing Zₐ dose rate of the X-ray beam having the lowest level of average power. In the example illustrated in FIG. 3, three of these junctions p-n are distributed according to depths P1, P2, P3 in the zone of increasing Zₐ₁ dose rate of the X-ray beam having the lowest level of average power specifically <E₁>. These three junctions p-n stacked according to the depths P1, P2, P3 in the zone of increasing Zₐ₁ are also necessarily distributed in the zone of increasing Zₐ₂ dose rate of the X-ray beam having a higher level of average power specifically <E2>. It should be noted that in the example illustrated four junctions p-n are distributed according to depths P1, P2, P3, P4 in the zone of increasing Zₐ₂ dose rate for the X-ray beam of average power <E2>.

Typically, at least three of the junctions p-n are distributed in a depth zone at most equal to 20 pm from the face exposed to the X-ray beam of the monolithic detector 3.

Of course, the monolithic detector 3 can comprise a number m of junctions p-n significantly greater than three to improve measuring precision and reliability and to widen the power measuring range. Similarly, it can be provided to distribute these m junctions uniformly or not over the entire zone of increasing dose rate of the X-ray beam whereof the average power is the highest, while preserving at least three junctions in the zone of increasing dose rate of the X-ray beam whereof the average power is the lowest.

According to an advantageous embodiment characteristic, for a given range of average power, the m junctions p-n are stacked depthwise so as to position at least three junctions p-n in the zone of increasing dose rate for the X-ray beam having the lowest level of average power, and at least two junctions p-n around the characteristic depth Pₘₐₓ for the X-ray beam having the highest level of average power.

The m signals (currents) delivered by the m junctions p-n of the detector 3 are measured and processed to the extent where they characterize the quality of the X-ray beam.

According to an advantageous embodiment characteristic, the measuring and processing circuit 4 is configured to retrieve the m signals rᵢ (i=1, . . . m) originating from the junctions p-n from the m signals delivered by the detector. The measuring and processing circuit 4 is configured to process the m signals rᵢ (i=1, . . . m) by calculating m−1 the following relative differentiation values dᵢ:

$${d}_{i} = \frac{( {r}_{i + 1} - {r}_{i} )}{\frac{( {r}_{i + 1} + {r}_{i} )}{2}} {\vert}_{i = 1 à m - 1}$$

FIG. 7 illustrates the values of differentiation of first order of the four signals delivered by the detector having four junctions p-n, for different average powers of the X-ray beam. The graphics of FIG. 7 show, for different powers of the X-ray beam, the three values of differentiation of first order d₁, d₂, d₃ corresponding to the differentiations respectively between the signals r₁ and r₂, r₂ and r₃, r₃ and r₄.

Analysis of the relative differentiation values of first order dᵢ appreciates especially the slope of the profile of dose deposit rate on the zone of increasing dose rate.

According to an advantageous embodiment characteristic, the measuring and processing circuit 4 is configured for determining the growth rate of the profile of the dose rate from the m−1 relative differentiation values of first order dᵢ, this growth rate of the dose rate profile being made on the zone of increasing Zₐ before electronic balance. This growth rate depends on the average power of the incident X-ray beam, this which represents a parameter for specifying the quality of the incident X-ray beam.

According to another advantageous embodiment characteristic, the measuring and processing circuit 4 is configured, from the m−1 relative differentiation values of first order dᵢ to calculate the m−2 relative differentiation values of the following second order d_{′i}:

$${d}_{i}^{′} = \frac{( {d}_{i + 1} - {d}_{i} )}{\frac{( {d}_{i + 1} + {d}_{i} )}{2}} {\vert}_{i = 1 à m - 2}$$

FIG. 8 illustrates the values of differentiation of the second order from the four signals delivered by the detector, for different average powers of the X-ray beam. For different powers of the X-ray beam, the graphics of FIG. 8 show the two values of differentiation of second order d′₁, d′₂, corresponding to the differentiations respectively between the values of first order d₁ and d₂, d₂ and d₃.

Analysis of values of differentiation of second order d_{′i} appreciates the curvature of the profile of dose deposit rate on the zone of increasing dose rate. This curvature in negative values which depends on the average power of the incident X-ray beam is a monotone function of the power characteristic of the beam, which represents another parameter for specifying the quality of the incident X-ray beam.

According to another advantageous embodiment characteristic, the measuring and processing circuit 4 is configured, from the m values of signals r, the m−1 relative differentiation values of first order dᵢ and the m−2 relative differentiation values of the second order d_{′i}, for determining the appearance of the profile of dose deposit rate on the zone of increasing dose rate and the characteristic depth Pₘₐₓ. This determination can be made by injection of these values in a dedicated parametric model (empirical, analytical model or resulting from Monte-Carlo simulations).

According to another advantageous embodiment characteristic, the measuring and processing circuit 4 is configured for determining the curvature of the profile of the dose rate from the m−2 relative differentiation values of the second order of d′i. This curvature in negative values is a monotone function of the average power of an incident X-ray beam. It is all the more negative since the average power of the incident X-ray beam is low, which represents a parameter for specifying the quality of the incident X-ray beam. For a given irradiation configuration (filtration, diaphragm, collimation, angle of incidence), when only the high voltage applied to the X-ray tube is varied, there is a monotone relation between the quality of the incident X-ray beam and the curvature of the profile. This monotone relation can be predetermined by measuring or simulation, and used as reference to determine the quality of the beam from the curvature of the profile in the zone of increasing dose rate.

The measuring and processing circuit 4 is also configured to exploit on the one hand the m signals r of the junctions p-n which are proportional to the dose rate of the incident beam and on the other hand the quality of beam for determining the dose rate at given depths or at points of interest. The quality of the beam is used to compensate the power dependence on the response of the detector and to be able to determine the dose rate at given depths or at points of interest.

According to another advantageous embodiment characteristic, the measuring and processing circuit 4 is configured so as to constitute, from the m−1 relative differentiation values of first order dᵢ and the m−2 relative differentiation values of the second order of d_{′i}, a vector D of 2m−3 elements defined by

$$D = [ \begin{matrix}{α}_{1} {d}_{1} \\ ⋮ \\ {α}_{m - 1} {d}_{m - 1} \\ {α}_{1}^{′} {d}_{1}^{′} \\ ⋮ \\ {α}_{m - 2}^{′} {d}_{m - 2}^{′}\end{matrix} ]$$

where α₁ . . . αₘ₋₁, and α′₁ . . . α′_{m1_2} are weighting coefficients between 0 and 1.

FIG. 9 presents the components of the relative differentiation vector D of the signals, for several powers of an X-ray beam. This figure shows that the relative contributions of these different components depend considerably on the power characteristic of the beam and can be used to specify the quality of an X-ray beam. This figure shows that the distribution of these different components is specific for each power characteristic of the beam and can be used to specify the quality of the X-ray beam.

FIG. 10 illustrates the values of correlation for different powers of the X-ray beam, between the relative differentiation vector D for the X-ray beam and tabulated reference vectors. The correlation maximum unambiguously indicates the power of the incident beam and therefore specifies the quality of the incident X-ray beam.

The object of the invention applies advantageously for equipment generating X-rays whereof the n values of high voltage applied to the tube produce n spectra of different incident X-rays corresponding to different beam qualities. The measuring and processing circuit 4 is configured to determine the vectorial correlation between the measured vector D and the tabulated n reference vectors (obtained for each value of the high voltage by measurements or Monte-Carlo simulations). The correlation maximum indicates the high voltage used and specifies the quality of the corresponding X-ray beam.

Similarly, for equipment generating X-rays whereof the settings including filtration produce k use configurations with different beam qualities, the measuring and processing circuit 4 is configured to determine the vectorial correlation between the measured vector D and k reference vectors tabulated for these configurations (obtained by calibration measurements or Monte-Carlo simulations). The correlation maximum indicates the configuration used and specifies the quality of the X-ray beam.

The device 1 according to the invention characterizes the quality of an X-ray beam F, by means of one of the methods which derive directly from the description hereinabove. In particular, the device and the method forming the object of the invention can characterize in addition to the quality of an X-ray beam other radiological parameters of dosimetric interest such as for example the dose rate, the high voltage applied to the tube (kVp), the semi-attenuation thickness (HVL), total filtration, the duration of pulses, the frequency of pulses and dose per pulse. Also, estimation of beam quality could serve to compensate the dependence of power on the response of diodes p-n on silicon.

It follows from the preceding description that the characterization method according to the invention comprises the following steps:
providing a monolithic detector integrating m junctions p-n stacked (m=3) depthwise of said detector with at least three junctions distributed in the zone of increasing dose rate;
projecting said X-ray beam onto the monolithic detector;
retrieving the m signals r delivered by the junctions p-n of the detector;
and processing the m signals r for characterizing the quality of the X-ray beam.

The m signals r are then processed by the measuring and processing circuit 4 as described already.

The invention is not limited to the examples described and represented, since various modifications can be made without departing from its scope.

1. A method for characterizing the quality of an X-ray beam comprising a known profile of dose deposit in a body having a zone of increasing (Za1, Za2) dose rate inside said body extending between the input surface of the beam and a characteristic depth (Pmax) where the deposited dose rate is maximal, the method comprising the following steps:
providing a monolithic detector integrating m junctions p-n stacked (m>=3) depthwise of said detector with at least three junctions distributed in the zone of increasing dose rate;
projecting said X-ray beam onto the monolithic detector;
retrieving the m signals (r) delivered by the junctions p-n of the detector;
and processing the m signals (r) for characterizing the quality of the X-ray beam.

2. The method according to claim 1, characterized in that it consists of processing the m signals (r) by calculating m−1 relative differentiation values of the following first order di:
$${d}_{i} = \frac{( {r}_{i + 1} - {r}_{i} )}{\frac{( {r}_{i + 1} + {r}_{i} )}{2}} {\vert}_{i = 1 à m - 1}$$

3. The method according to claim 2, characterized in that from the m−1 relative differentiation values of first order (d1) it consists of calculating the m−2 relative differentiation values of the following second order (d′i):
$${d}_{i}^{′} = \frac{( {d}_{i + 1} - {d}_{i} )}{\frac{( {d}_{i + 1} + {d}_{i} )}{2}} {\vert}_{i = 1 à m - 2}$$

4. The method according to claim 1, characterized in that, from the m values of signals r, m−1 relative differentiation values of first order di and of the m−2 relative differentiation values of the second order d′i, it consists of determining the appearance of the profile of dose deposit rate on the zone of increasing dose rate as well as the characteristic depth (Pmax).

5. The method according to claim 1, characterized in that it consists of determining the curvature of the profile of the dose rate from the m−2 relative differentiation values of the second order (d′1), this curvature in zone of increasing dose rate assuming negative values and presenting a monotone function of the power characteristic of the beams, coming up to the quality of the incident X-ray beam.

6. The method according to claim 1, characterized in that it consists of determining the growth rate of the profile of the dose rate from the m−1 relative differentiation values of first order (di), this growth rate coming up to the quality of the incident X-ray beam.

7. The method according to claim 1, characterized in that from the m−1 relative differentiation values of first order (di) and the m−2 relative differentiation values of the second order (d′i), it consists of constituting a vector of 2m−3 elements defined by:
$$D = [ \begin{matrix}{α}_{1} {d}_{1} \\ ⋮ \\ {α}_{m - 1} {d}_{m - 1} \\ {α}_{1}^{′} {d}_{1}^{′} \\ ⋮ \\ {α}_{m - 2}^{′} {d}_{m - 2}^{′}\end{matrix} ]$$
where α1 . . . αm−1, and α′1 . . . α′m1_2 are weighting coefficients between 0 and 1.

8. The method according to claim 7, characterized in that it consists, for equipment generating X-rays whereof the power settings produce n spectra with different beam qualities, determining the vectorial correlation between the measured vector (D) and n predetermined reference vectors corresponding to these n spectra, the correlation maximum indicating the spectrum of the X-ray beam and therefore the quality of this beam.

9. The method according to claim 7, characterized in that, for equipment generating X-rays whereof the settings including filtration produce k use configurations with different beam qualities, it consists of determining the vectorial correlation between the measured vector (D) and k reference vectors predetermined for these configurations, the correlation maximum indicating the configuration used and therefore the quality of the X-ray beam.

10. The method according to claim 1, characterized in that it consists of exploiting both the m signals (r) of the junctions p-n which are proportional to the dose rate of the incident beam and also the quality of beam for determining the dose rate at a given depth.

11. The method according to claim 1, characterized in that it consists of distributing the m junctions p-n so as to position at least three junctions p-n in the zone of increasing dose rate for the X-ray beam with the lowest level of power, and at least two junctions p-n near the characteristic depth (Pmax) for the X-ray beam with the highest level of power.

12. A device for characterizing the quality of an X-ray beam comprising a known profile of dose deposit in a body having a zone of increasing dose rate inside said body extending between the input surface of the beam and a characteristic depth (Pmax) where the deposited dose rate is maximal, characterized in that the device comprises
a monolithic detector having m junctions p-n stacked depthwise of said detector with at least three of said junctions distributed in a zone corresponding to the zone of increasing dose rate for the lowest beam quality index of the measuring zone
a measuring and processing circuit (4) connected to the monolithic detector, the measuring and processing circuit (4) retrieving the m signals delivered by the m junctions p-n of the detector and processing the m signals for characterizing the quality of the X-ray beam.

13. The device according to claim 12, characterized in that the monolithic detector having m junctions p-n stacked depthwise is a detector having multiple buried junctions p-n or a detector obtained by manufacturing processes or 3D microelectronic integration.

14. The device according to claim 12, characterized in that at least three of the junctions p-n are distributed in a depth zone at most equal to 20 pm from the implantation face of the monolithic detector.

15. The device according to claim 12, characterized in that the measuring and processing circuit is adapted for:
retrieving the m signals ri originating from the junctions p-n from the m signals delivered by the detector;
calculating the following m−1 relative differentiation magnitudes:
$${d}_{i} = \frac{( {r}_{i + 1} - {r}_{i} )}{\frac{( {r}_{i + 1} + {r}_{i} )}{2}} {\vert}_{i = 1 à m - 1}$$
calculating, from the relative m−1 differentiation magnitudes, the relative m−2 differentiation magnitudes of the following second order:
$${d}_{i}^{′} = \frac{( {d}_{i + 1} - {d}_{i} )}{\frac{( {d}_{i + 1} + {d}_{i} )}{2}} {\vert}_{i = 1 à m - 2}$$

16. The device according to claim 15, characterized in that the measuring and processing circuit is adapted for calculating the maximum of the vectorial correlation between n reference vectors and the following vector (D) having 2m−3 elements:
$$D = [ \begin{matrix}{α}_{1} {d}_{1} \\ ⋮ \\ {α}_{m - 1} {d}_{m - 1} \\ {α}_{1}^{′} {d}_{1}^{′} \\ ⋮ \\ {α}_{m - 2}^{′} {d}_{m - 2}^{′}\end{matrix} ]$$
where α1 . . . αm−1, and α′1 . . . α′m1_2 are weighting coefficients between 0 and 1.
